(19) United States
(12) Patent Application Publication
(10) Pub. No.: US 2016/0125223 A1
(43) Pub. Date: May 5, 2016

(54) ELECTRONIC DEVICE INCLUDING MULTIPLE SPEED AND MULTIPLE ACCURACY FINGER BIOMETRIC MATCHING AND RELATED METHODS

(71) Applicant: APPLE INC., Cupertino, CA (US)

(72) Inventors: Michael BOSHRA, Melbourne, FL (US); Pavel Ricka, Prague 3 (CZ); Petr Kostka, Prague 3 (CZ); Jan Cibulka, Prague 3 (CZ)

(21) Appl. No.: 14/528,361

(22) Filed: Oct. 30, 2014

(51) Int. Cl. G06K 9/00

(52) U.S. Cl. CPC G06K 9/00087; G06K 9/00013

(57) ABSTRACT

An electronic device may include a finger biometric sensor and a processor and a memory coupled thereto. The processor is capable of performing a first matching to determine a first matching score of sensed finger biometric data against finger biometric template data stored in the memory, and indicating a match and updating the finger biometric template data when the first matching score exceeds a first threshold. The processor is also capable of performing a second matching of the sensed finger biometric data against the stored finger biometric template data to determine a second matching score when the first matching score does not exceed the first threshold and updating the finger biometric template data stored in the memory when the second matching score is above a second threshold. The second matching is slower but more accurate than the first matching.

### FIELD OF THE INVENTION

The present invention relates to the field of electronics, and, more particularly, to the field of finger sensors.

### BACKGROUND

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

A fingerprint sensor may be particularly advantageous for verification and/or authentication in an electronic device, and more particularly, a portable device, for example. Such a fingerprint sensor may be carried by the housing of a portable electronic device, for example, and may be sized to sense a fingerprint from a single-finger.

Where a fingerprint sensor is integrated into an electronic device or host device, for example, as noted above, it may be desirable to more quickly perform authentication, particularly while performing another task or an application on the electronic device. In other words, it may be particularly undesirable to have a user wait while a fingerprint is processed for authentication. Performing a fingerprint authentication with a reduced user delay and while maintaining a desired level of accuracy may be increasingly difficult when a fingerprint sensor is integrated in a host device, such as a personal computer or cellphone.

### SUMMARY

An electronic device may include a finger biometric sensor and at least one processor and a memory coupled thereto. The at least one processor may be capable of performing a first matching to determine a first matching score of sensed finger biometric data from the finger biometric sensor against finger biometric template data stored in the memory, and indicating a match and updating the finger biometric template data when the first matching score exceeds a first threshold. The at least one processor may also be capable of performing a second matching of the sensed finger biometric data against the stored finger biometric template data to determine a second matching score when the first matching score does not exceed the first threshold, and updating the finger biometric template data stored in the memory when the second matching score is above a second threshold. The second matching is slower but more accurate than the first matching. Accordingly, a more efficient finger biometric match and finger biometric template may be performed, for example, with a reduced impact on user experience or processing time and matching accuracy.

The at least one processor may be capable of performing the second matching in a plurality of separate sub-matching steps. The at least one processor may include a first processor capable of performing the first matching and indicating the match and a second processor capable of performing the second matching, for example.

The electronic device may further include a housing and a user input device carried by the housing. The user input device may carry the finger biometric sensor, for example.

The electronic device may also include a wireless transceiver coupled to the at least one processor. The finger biometric sensor may be a static finger biometric sensor, for example.

A method aspect is directed to a method of finger biometric matching. The method includes using at least one processor and a memory coupled thereto to perform a first matching to determine a first matching score of sensed finger biometric data from a finger biometric sensor coupled to the at least one processor against finger biometric template data stored in the memory. The method also includes using the at least one processor to indicate a match and updating the finger biometric template data when the first matching score exceeds a first threshold, and perform a second matching of the sensed finger biometric data against the stored finger biometric template data to determine a second matching score when the first matching score does not exceed the first threshold, and updating the finger biometric template data stored in the memory when the second matching score is above a second threshold. The second matching is slower but more accurate than the first matching.

### BRIEF DESCRIPTION OF DRAWINGS

FIG. 1 is a plan view of an electronic device according to an embodiment.

FIG. 2 is a schematic block diagram of an electronic device according to an embodiment.

FIG. 3 is a flow diagram illustrating operation of the electronic device of FIG. 2.

FIGS. 4a and 4b are diagrams illustrating exemplary restructuring of the matcher in accordance with an embodiment.

FIG. 5 is a schematic block diagram of an electronic device according to an embodiment.

FIG. 6 is a flow diagram illustrating operation of the electronic device of FIG. 5.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

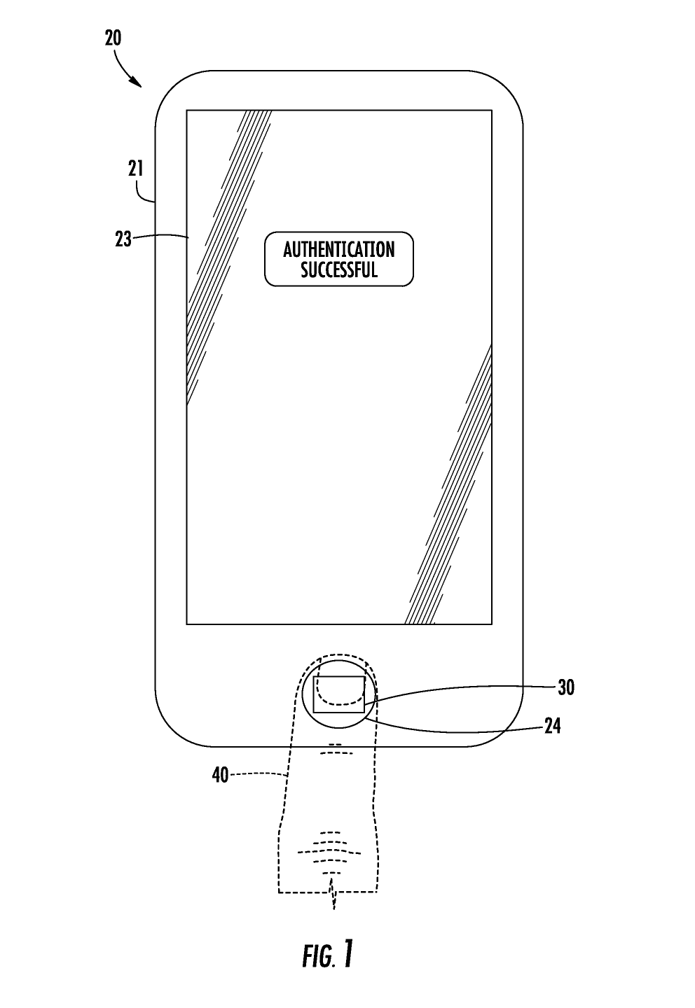

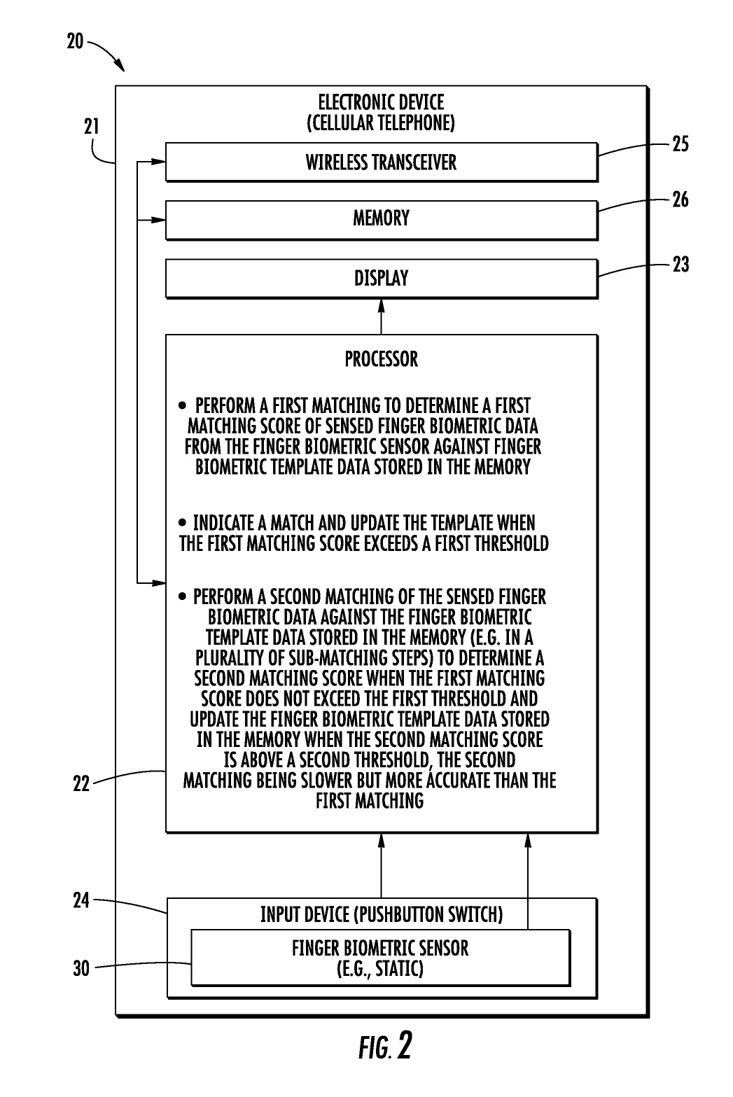

Referring initially to FIGS. 1 and 2, an electronic device 20 is now described. The electronic device 20 illustratively includes a housing, for example, a portable housing 21, and a processor 22 carried by the portable housing. The processor 22 or any part thereof may be secure and operate in a secure environment, for example.

The electronic device 20 is illustratively a mobile wireless communications device, for example, a cellular telephone. The electronic device 20 may be another type of electronic device, for example, a tablet computer, laptop computer, etc.

A wireless transceiver 25 is also carried within the housing 21 and coupled to the processor 22. The wireless transceiver 25 cooperates with the processor 22 to perform at least one wireless communications function, for example, for voice and/or data. In some embodiments, the electronic device 20 may not include a wireless transceiver 25 or other wireless communications circuitry.

A display 23 is also carried by the portable housing 21 and is coupled to the processor 22. The display 23 may be a liquid crystal display (LCD), for example, or may be another type of display, as will be appreciated by those skilled in the art. A memory 26 is also coupled to the processor 22. The memory 26 is for storing finger matching biometric template data, as will be described in further detail below. The memory 26 may store other or additional types of data, as will be appreciated by those skilled in the art.

A finger-operated user input device, illustratively in the form of a pushbutton switch 24, is also carried by the portable housing 21 and is coupled to the processor 22. The pushbutton switch 24 cooperates with the processor 22 to perform one or more device functions in response to the pushbutton switch. For example, a device function may include a powering on or off of the electronic device 20, initiating communication via the wireless transceiver 25, and/or performing a menu function.

More particularly, with respect to a menu function, the processor 22 may change the display 23 to show a menu of available applications based upon pressing of the pushbutton switch 24. In other words, the pushbutton switch 24 may be a home switch or button, or key. Of course, other device functions may be performed based upon the pushbutton switch 24, for example, switching to a user-interface unlocked mode. In some embodiments, the finger-operated user input device may be a different type of finger-operated user input device, for example, forming part of a touch screen display. Other or additional finger-operated user input devices may be carried by the portable housing 21.

A finger biometric sensor 30 is carried by the pushbutton switch 24 to sense a user's finger 40 or an object placed adjacent the finger biometric sensor. The finger biometric sensor 30 is carried by the pushbutton switch 24 so that when a user contacts and/or presses downward on the pushbutton switch, data from the user's finger 40 is acquired, for example, for finger matching and/or spoof detection, as will be appreciated by those skilled in the art. In other words, the finger biometric sensor 30 may be responsive to static contact or placement of the user's finger 40 or object. Of course, in other embodiments, for example, where the finger biometric sensor 30 is not carried by a pushbutton switch, the finger biometric sensor may be a slide sensor and may be responsive to sliding contact, or the finger biometric sensor may be a standalone static placement sensor.

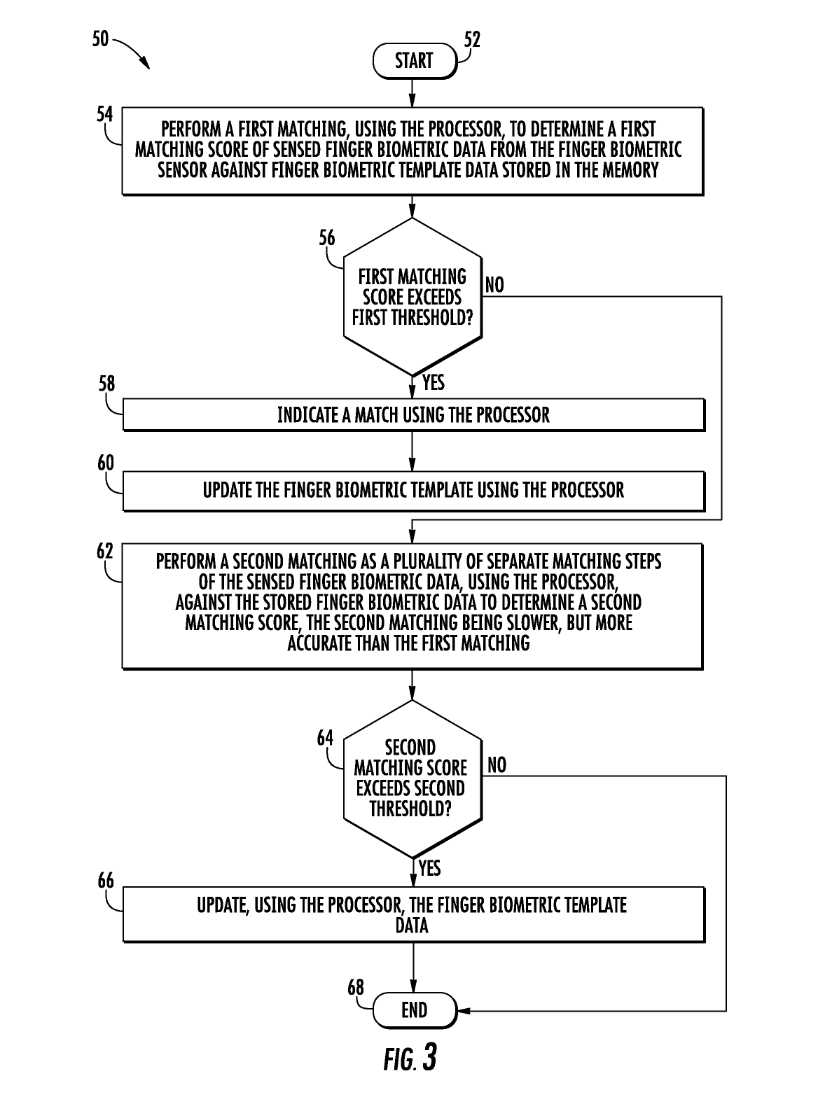

Referring now additionally to the flowchart 50 in FIG. 3, operation of the electronic device 20 is now described. Beginning at Block 52, the processor 22 performs a first matching to determine a first matching score of sensed finger biometric data against finger biometric template data stored in the memory 26 (Block 54). The finger biometric data is sensed via the finger biometric sensor 30.

At Block 56, the processor 22 determines whether there is a match, for example if the matching score exceeds a first threshold, for example a matching threshold. If the first match score exceeds the first threshold, the processor 22 indicates a match (Block 58). If, at Block 56, the first matching score exceeds the first threshold, the processor 22, after indicating a match at Block 58, updates the finger biometric template data (Block 60). In some embodiments, there may be different thresholds, one for matching and one for updating the finger biometric template, which may be more restrictive than the matching threshold. The thresholds may be set based upon a desired level of security, as will be appreciated by those skilled in the art.

At Block 62, when the first matching score does not exceed the threshold, the processor 22 performs a second matching of the sensed finger biometric data against the stored finger biometric template data to determine a second matching score. The second matching is slower, since it is more elaborate so as to be more accurate than the first matching. The second matching may be performed in a series of separate sub-matching steps. In other words, the processor 22 may break up the second matching process so that it can be pre-empted, for example, to allow running of other processes that may be unrelated to the matching process.

When the second matching score is above a second threshold, Block 64, for example, indicative of a better match, the processor 22 updates the finger biometric template data stored in the memory 26 (Block 66). The method ends at Block 68. The second threshold may be different, for example, corresponding to a better match or being more restrictive, or may be the same as the first threshold.

As will be appreciated by those skilled in the art, a finger biometric matching operation may involve the use of an indexer and a matcher where the indexer may be considered as the first matching functions run on the processor 22, and the matcher may be considered as the more elaborate, or second, matching functions performed on the processor 22.

An exemplary matcher may generate, based upon sensed finger biometric data, an initial ridge orientation characteristic map by at least tessellating the finger biometric data into an array of cells. The initial ridge orientation characteristic map may further be generated by at least estimating at least one respective gradient for each cell and generating the initial ridge orientation characteristic map based upon the estimated gradients. An amount of noise in the initial ridge orientation characteristic map is estimated and the initial ridge orientation characteristic map is adaptively filtered based upon the amount of estimated noise therein to generate a finger ridge orientation characteristic map. Further details of an exemplary matcher, for example, may be found in U.S. Pat. No. 7,599,530, the entire contents of which are hereby incorporated by reference. Of course, other and/or additional types of matchers may be used.

An exemplary indexer may determine enrollment finger ridge flow angles over an enrollment area for an enrolled finger, and determine match finger ridge flow angles over a match area for a to-be matched finger. At least one likely match sub-area of the enrollment area may be determined, by dividing the enrollment area into a plurality of regions and determining a respective enrollment ridge flow histogram for each region of the enrollment area. A determination may be made as to whether the to-be matched finger matches the enrolled finger based upon the at least one likely match sub-area. Further details of an exemplary indexer may be found in U.S. Application Publication No. 2014/0270420 assigned to the present assignee, and the entire contents of which is hereby incorporated by reference. Of course, other and/or additional indexers may be used.

Moreover, it may be particularly advantageous, for example, with respect to speed and accuracy, to perform matching of sensed finger biometric data as separate matching steps. However, the second matching may be significantly slower than the first matching. Performing a full-matching or elaborate matching operation, for example, may be impractical in terms of a longer response time for a match indication. Moreover, performing a full-matching operation on the processor 22 may also tie-up the processor so as to prevent other processes from being performed.

By performing the first matching and indicating the match, and performing the second matching as a sequence of sub-matching steps as described above, more desirable response times can be achieved, for example, 0.5-1.5 seconds on the first processor. In other words, with respect to authentication, the indexer provides a generally quick response time or match indication to the user, and the finger biometric template may be updated in the background by the processor 22 after providing the match indication to the user. Additionally, there is some tradeoff of accuracy, as the indexer and matcher approach may result in a FRR of about 3% with 95% of the sensed finger biometric data updating the finger biometric template while 5% does not update the finger biometric template. The second matching may increase the template update percentage from 95% to 97%, thus providing the increased ability to track changes in finger conditions, for example. In some instances, as will be appreciated by those skilled in the art, where there is a failure of the first matching to achieve a sufficiently high score to justify updating the template, a more comprehensive match operation may be performed by the first processor 32, which may include the first and second matching.

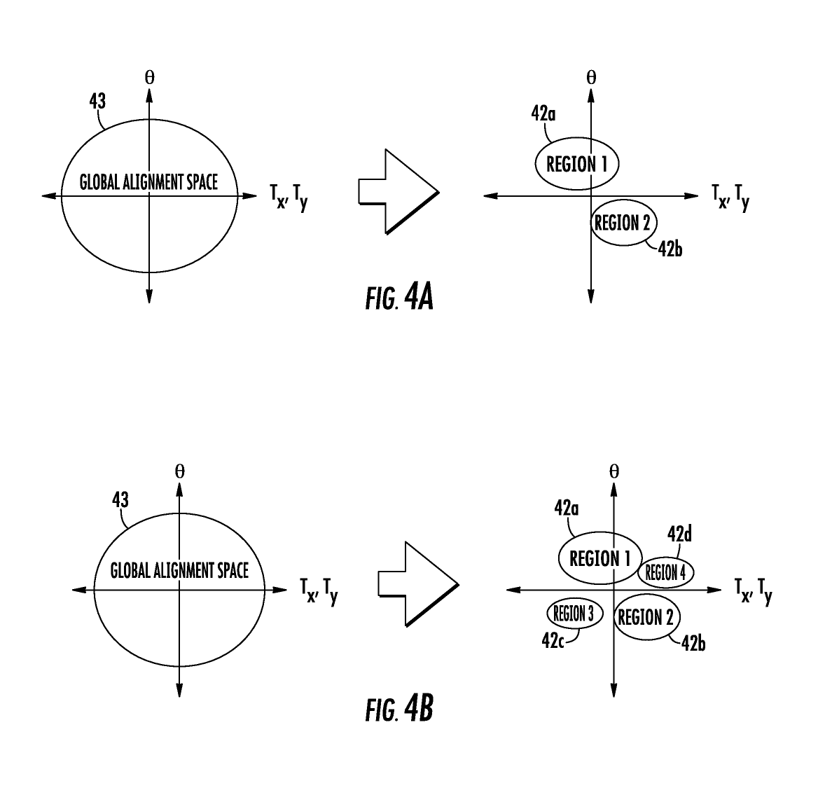

Referring now to FIGS. 4a and 4b, operation of an example indexer and matcher is now described. The indexer finds, relatively quickly, from the global alignment space 43 likely alignment regions 42a, 42b and provides an ordered list of those regions to the matcher for sequential examination (FIG. 4a). This process generally lends itself well to breaking a matching operation into a relatively long sequence of smaller sub-matches, as described above. For example, instead of requesting the top two matching regions from the global alignment space 43, the top four matching regions 42a-42d may be requested (FIG. 4b).

To increase accuracy, the indexer is reconfigured to provide further accuracy at the expense of increased match time (e.g., by providing more alignment regions). The matcher is “restructured” using the indexer configuration described above.

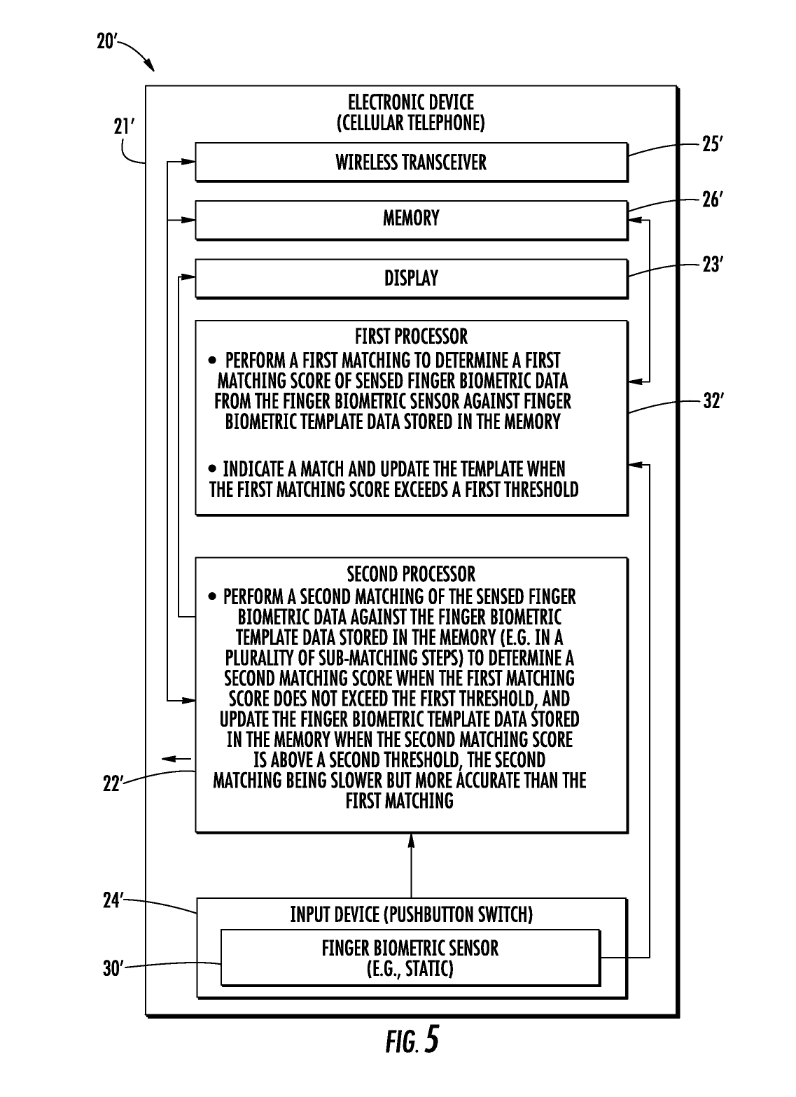

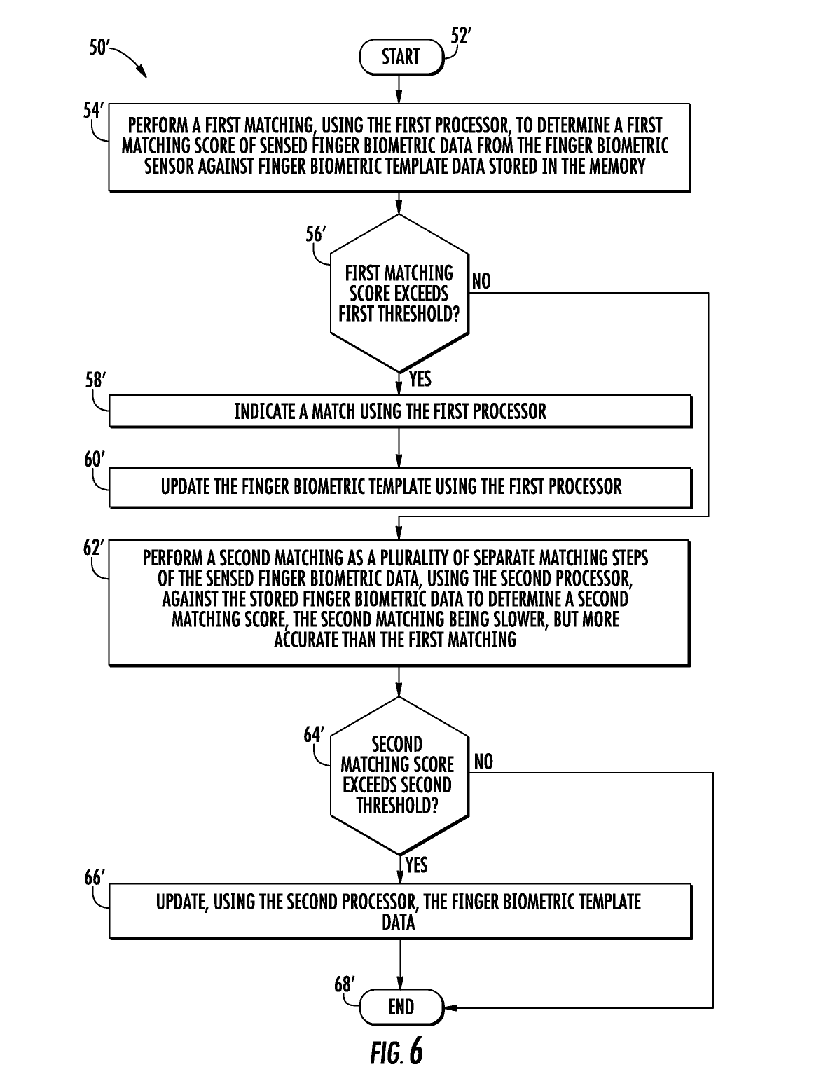

Referring initially to FIGS. 5 and 6, an electronic device 20′ according to another embodiment is now described. The electronic device 20′ illustratively includes a housing, for example, a portable housing 21′, and first and second processors 32′, 22′ carried by the portable housing. The first processor 32′ may be for a specific function or type of processing.

The electronic device 20′ is illustratively a mobile wireless communications device, for example, a cellular telephone. The electronic device 20′ may be another type of electronic device, for example, a tablet computer, laptop computer, etc.

A wireless transceiver 25′ is also carried within the housing 21′ and coupled to the second processor 22′. The wireless transceiver 25′ cooperates with the second processor 22′ to perform at least one wireless communications function, for example, for voice and/or data. In some embodiments, the electronic device 20′ may not include a wireless transceiver 25 or other wireless communications circuitry.

A display 23′ is also carried by the portable housing 21′ and is coupled to the second processor 22′. The display 23′ may be a liquid crystal display (LCD), for example, or may be another type of display, as will be appreciated by those skilled in the art. A memory 26′ is also coupled to the first and second processors 32′, 22′. The memory 26′ is for storing finger matching biometric template data, as noted above. The memory 26′ may store other or additional types of data, as will be appreciated by those skilled in the art.

A finger-operated user input device, illustratively in the form of a pushbutton switch 24′, is also carried by the portable housing 21′ and is coupled to the second processor 22′. The pushbutton switch 24′ cooperates with the second processor 22′ to perform one or more device functions in response to the pushbutton switch as described above. A finger biometric sensor 30′ similar to that described above is carried by the pushbutton switch 24′ to sense a user's finger 40′ or an object placed adjacent the finger biometric sensor.

Referring now additionally to the flowchart 50′ in FIG. 6, operation of the electronic device 20′ is now described. Beginning at Block 52′, the first processor 32′ performs a first matching to determine a first matching score of sensed finger biometric data against finger biometric template data stored in the memory 26′ (Block 54′). The finger biometric data is sensed via the finger biometric sensor 30′.

At Block 56′, the first processor 32′ determines whether there is a match, for example if the first matching score exceeds a first threshold. If the first matching score exceeds the first threshold, the first processor 32′ indicates a match (Block 58′). If, at Block 56′, the first matching score exceeds the first threshold, the first processor 32′, after indicating a match at Block 58′, updates the finger biometric template data (Block 60′). Similar to that described above, in some embodiments, there may be two thresholds, one for matching and one for updating the finger biometric template.

At Block 62′, when the first matching score does not exceed the first threshold, the second processor 22′ performs a second matching of the sensed finger biometric data against the stored finger biometric template data to determine a second matching score. The second matching is slower, since it is more exhaustive or elaborate so as to be more accurate than the first matching. The second matching may be performed in a series of separate sub-matching steps. In other words, the second processor 22′, which may in some embodiments, be a faster processor than the first processor 32′ in terms of speed, may break up the second matching process for other processes that may be unrelated to the matching processes.

When the second matching score is above a second threshold, Block 64′, the second processor 22′ updates the finger biometric template data stored in the memory 26′ (Block 66′). The method ends at Block 68′.

While in this embodiment, the first and second matching processes have been described with respect to two processors, it should be understood that any number processors may be used, and the first matching and second matching may be spread across or over the processors.

Many modifications and other embodiments will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An electronic device comprising:
a finger biometric sensor;
at least one processor and a memory coupled thereto, the at least one processor capable of
performing a first matching to determine a first matching score of sensed finger biometric data from the finger biometric sensor against finger biometric template data stored in the memory,
indicating a match and updating the finger biometric template data when the first matching score exceeds a first threshold, and
performing a second matching of the sensed finger biometric data against the stored finger biometric template data to determine a second matching score when the first matching score does not exceed the first threshold, and updating the finger biometric template data stored in the memory when the second matching score is above a second threshold, the second matching being slower but more accurate than the first matching.

2. The electronic device of claim 1 wherein the at least one processor is capable of performing the second matching in a plurality of separate sub-matching steps.

3. The electronic device of claim 1 wherein the at least one processor comprises a first processor capable of performing the first matching and indicating the match.

4. The electronic device of claim 3 wherein the at least one processor comprises a second processor capable of performing the second matching.

5. The electronic device of claim 1 further comprising a housing and a user input device carried by the housing; and wherein the user input device carries the finger biometric sensor.

6. The electronic device of claim 1 further comprising a wireless transceiver coupled to the at least one processor.

7. The electronic device of claim 1 wherein the finger biometric sensor comprises a static finger biometric sensor.

8. An electronic device comprising:
a housing;
a user input device carried by housing;
a finger biometric sensor carried by the user input device; and
at least one processor and a memory coupled thereto, the at least one processor capable of
performing a first matching to determine a first matching score of sensed finger biometric data from the finger biometric sensor against finger biometric template data stored in the memory,
indicating a match and updating the finger biometric template data when the first matching score exceeds a first threshold, and
performing a second matching of the sensed finger biometric data against the stored finger biometric template data to determine a second matching score when the first matching score does not exceed the first threshold and updating the finger biometric template data stored in the memory when the second matching score is above a second threshold, the second matching being slower but more accurate than the first matching, and being performed in a plurality of separate sub-matching steps.

9. The electronic device of claim 8 wherein the at least one processor comprises a first processor capable of performing the first matching and indicating the match.

10. The electronic device of claim 9 wherein the at least one processor comprises a second processor capable of performing the second matching.

11. The electronic device of claim 8 further comprising a wireless transceiver coupled to the at least one processor.

12. The electronic device of claim 8 wherein the finger biometric sensor comprises a static finger biometric sensor.

13. A method of finger biometric matching comprising:
using at least one processor and a memory coupled thereto to
perform a first matching to determine a first matching score of sensed finger biometric data from a finger biometric sensor coupled to the at least one processor against finger biometric template data stored in the memory,
indicate a match and updating the finger biometric template data when the first matching score exceeds a first threshold, and
perform a second matching of the sensed finger biometric data against the stored finger biometric template data to determine a second matching score when the first matching score does not exceed the first threshold, and updating the finger biometric template data stored in the memory when the second matching score is above a second threshold, the second matching being slower but more accurate than the first matching.

14. The method of claim 13 wherein the at least one processor performs second matching in a plurality of separate sub-matching steps.

15. The method of claim 13 wherein the at least one processor comprises a first processor that performs the first matching and indicates the match.

16. The method of claim 15 wherein the at least one processor comprises a second processor that performs the second matching.

17. The method of claim 13 wherein the finger biometric sensor comprises a static finger biometric sensor.
